(19) United States
(12) Patent Application Publication
(10) Pub. No.: US 2019/0264967 A1
(43) Pub. Date: Aug. 29, 2019

(54) MULTI-STAGE COMPRESSING SYSTEM AND CONTROL METHOD THEREOF

(71) Applicant: KYUNGWON MACHINERY CO., LTD., Siheung-si (KR)

(72) Inventors: Man Sig JU, Seoul (KR); Jung Hoon CHUNG, Siheung-si (KR); Jae-Jung BAE, Bucheon-si (KR)

(21) Appl. No.: 15/904,087

(22) Filed: Feb. 23, 2018

(51) Int. Cl. F25B 49/02; F25B 1/10; F04C 23/00; F04C 28/08

(52) U.S. Cl. CPC F25B 49/022; F25B 1/10; F16K 15/18; F04C 23/001; F04C 28/08; F25B 49/025

(57) ABSTRACT

The present disclosure relates to a multi-stage compression system in which the drive speed of each compressor that constitutes the multi-stage compression system is individually controlled to increase compression efficiency, and a control method thereof. To this end, the present disclosure includes at least two compressors, at least two driving devices connected to each of the compressors in series to drive the compressors connected in series, at least two pressure detectors installed at a discharge end of each of the compressors to detect a discharge pressure of each compressor, and a control unit configured to individually control a drive speed of each driving device based on the discharge pressure of each compressor detected through each of the pressure detectors.

### BACKGROUND

### 1. Field

The present disclosure relates to a multi-stage compression system and a control method thereof, and more particularly, to a multi-stage compression system in which the drive speed of each compressor that constitutes the multi-stage compression system is individually controlled to increase compression efficiency, and a control method thereof.

### 2. Description of the Related Art

An air compressor is a mechanical device which compresses air to increase the pressure in order to operate an air cylinder or a pneumatic device used for driving automation equipment, and to compress air, driving means such as diesel engines or electric motors is needed.

Among them, positive displacement compressors such as screw air compressors are divided into oil-injected compressors and oil-free compressors according to the compression method.

The oil-injected compressor supplies a refrigerant (oil) to a compression chamber to prevent the reduction in compression efficiency caused by the heat of compression generated during compression, and the oil-free compressor prevents the reduction in compression efficiency occurring due to the heat of compression through multi-stage compression in which stages of a compression process are divided and an intercooler is used.

Meanwhile, positive displacement compressors have volumetric efficiency varying depending on a drive speed and a pressure ratio of a suction end and a discharge end.

In general, a volume compression ratio of a compressor is associated with the shape of a discharge port, and is impossible to change because it is determined when designing.

Accordingly, as described above, when variations of volumetric efficiency occur depending on a drive speed and a pressure ratio of a suction end and a discharge end, the pressure of compressed air being discharged is less than or more than the design pressure, which results in re-compression or over-compression due to the characteristics of positive displacement compressors impossible to change the volume compression ratio determined when designing, causing an energy loss.

In the case of a multi-stage compression system, due to this phenomenon, variations of the discharge pressure in front stage (for example, first stage) affect the pressure ratio of compressor in rear stage (for example, second stage), and a difference between the final discharge pressure of the compressor and the design pressure becomes larger, causing an energy loss that is much greater than that of single-stage compression.

FIG. 1 is a schematic diagram showing the configuration of the conventional multi-stage compression system, and the conventional multi-stage compression system is driven using one driving device 1, and increasingly drives a first stage compressor 5 and a second stage compressor 7 using gears 3 on one drive axis. Accordingly, an energy loss occurs in the power transmission process of the gears 3, and because it is impossible, in principle, to change the drive speed ratio of the first stage compressor 5 and the second stage compressor 7, volumetric efficiency variations of each compressor 5, 7 take place differently, causing an additional energy loss.

### SUMMARY

The present disclosure is designed to solve the above-mentioned problem, and therefore the present disclosure is directed to providing a multi-stage compression system in which each compressor that constitutes the multi-stage compression system is connected to each driving device in series and the drive speed of each compressor is individually controlled by detecting the driving condition of each compressor, thereby increasing the energy efficiency and compression efficiency, and a control method thereof.

To achieve the above-described object, a multi-stage compression system according to an embodiment of the present disclosure includes at least two compressors, at least two driving devices connected to each of the compressors in series to drive the compressors connected in series, at least two pressure detectors installed at a discharge end of each of the compressors to detect a discharge pressure of each compressor, and a control unit configured to individually control a drive speed of each driving device based on the discharge pressure of each compressor detected through each of the pressure detectors.

Meanwhile, a control method for a multi-stage compression system according to an embodiment of the present disclosure includes operating, by a control unit, a driving device connected to each compressor to start driving the multi-stage compression system, in response to a driving start request, and after the driving starts, when a preset time passes, individually controlling a drive speed of each driving device based on a discharge pressure of each compressor detected through a pressure detector installed at a discharge end of each compressor.

According to the multi-stage compression system and the control method thereof according to the present disclosure, each compressor that constitutes the multi-stage compression system is connected to each driving device in series so that the multiplying gear is omitted, thereby removing a power transmission loss of the gears and increasing energy efficiency.

Additionally, the drive speed of each compressor that constitutes the multi-stage compression system is individually controlled by detecting the driving condition of each compressor, thereby increasing compression efficiency.

### BRIEF DESCRIPTION OF THE DRAWINGS

FIG. 1 is a schematic diagram showing the configuration of a conventional multi-stage compression system.

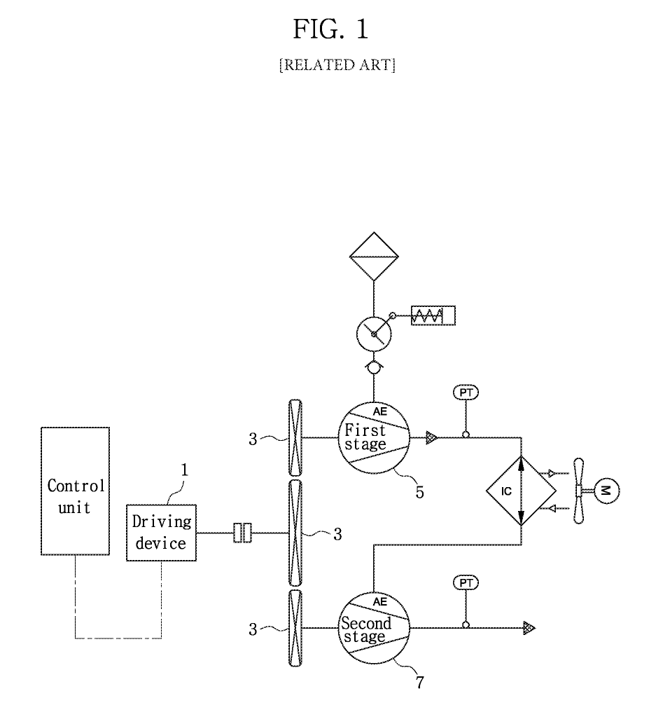

FIG. 2 is a schematic diagram showing the configuration of a multi-stage compression system according to an embodiment of the present disclosure.

FIG. 3 is a schematic diagram showing the configuration of a multi-stage compression system according to another embodiment of the present disclosure.

FIG. 4 is a processing diagram illustrating a control method for a multi-stage compression system according to an embodiment of the present disclosure.

### DETAILED DESCRIPTION

Hereinafter, a multi-stage compression system and a control method thereof according to an exemplary embodiment of the present disclosure will be described in detail with reference to the accompanying drawings.

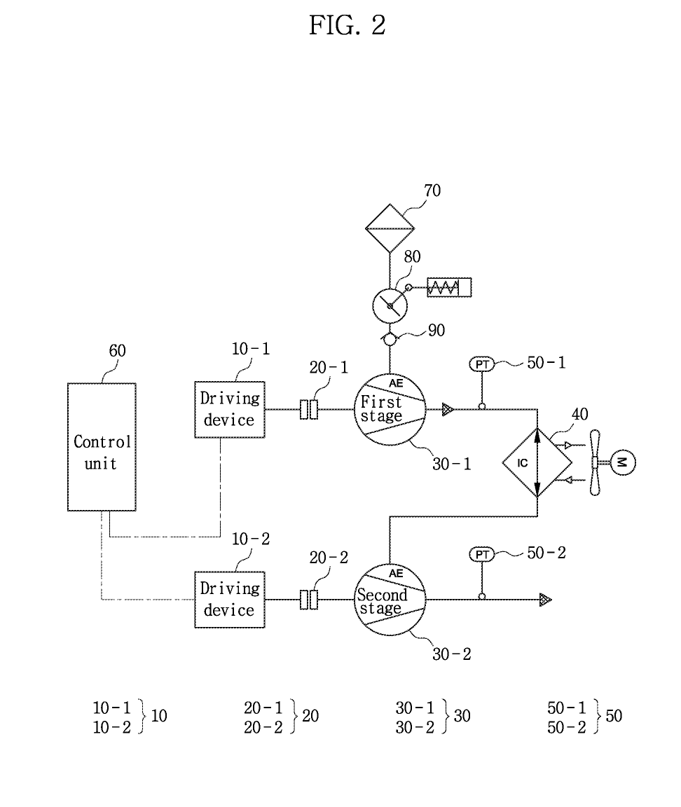

FIG. 2 is a schematic diagram showing the configuration of a multi-stage compression system according to an embodiment of the present disclosure.

In FIG. 2, each compressor 30:30-1, 30-2 compresses air to increase the pressure.

Each driving device 10:10-1, 10-2 is connected to each corresponding compressor 30:30-1, 30-2 in series, and drives the compressors 30:30-1, 30-2 connected in series.

Each coupling 20:20-1, 20-2 connects each compressor 30:30-1, 30-2 to its corresponding driving device 10:10-1, 10-2 in series.

The present disclosure has the same number of driving devices 10 as the compressor 30, and each compressor 30:30-1, 30-2 and each driving device 10:10-1, 10-2 are connected in series by the couplings 20:20-1, 20-2.

As described above, the present disclosure connects the compressor 30 to the driving device 10 in series, so that the multiplying gear is omitted, thereby removing a power transmission loss and increasing the energy efficiency compared to the conventional driving using one driving device.

Meanwhile, an intercooler 40 is installed between each compressor 30:30-1, 30-2, and cools the discharged air compressed by the front stage compressor 30-1 and supplies it to the rear stage compressor 30-2.

Each pressure detector 50:50-1, 50-2 is installed at a discharge end of each compressor 30:30-1, 30-2, and detects the discharge pressure of each compressor 30:30-1, 30-2 in real time and delivers the detected discharge pressure value to a control unit 60.

The control unit 60 individually controls the drive speed of each driving device 10 based on the discharge pressure of each compressor 30 detected through each pressure detector 50, and the control unit 60 controls the drive speed of the driving device 10-1 connected to the first stage compressor 30-1 based on the discharge pressure of the final stage (n^{th} stage) compressor 30-n, and the drive speed of the driving device 10-2, . . . , 10-n connected to the remaining stage (2^{nd} stage, . . . , n^{th} stage) compressor 30-2, . . . , 30-n based on the discharge pressure of the front stage (first stage, . . . , n-1^{th} stage) compressor 30-1, . . . , 30-(n-1).

Its more detailed description is as follows.

When the multi-stage compression system is a two-stage compression system, i.e., the multi-stage compression system has two compressors 30 as shown in FIG. 2, the control unit 60 controls the drive speed of the driving device 10-1 connected to the first stage compressor 30-1 based on the discharge pressure of the second stage compressor 30-2, and when the discharge pressure of the second stage compressor 30-2 is higher than the pressure based on the design pressure ratio (hereinafter referred to as ‘design pressure’), the control unit 60 reduces the drive speed of the driving device 10-1 connected to the first stage compressor 30-1 so that the discharge pressure of the second stage compressor 30-2 reaches the design pressure, and when the discharge pressure of the second stage compressor 30-2 is lower than the design pressure, the control unit 60 increases the drive speed of the driving device 10-1 connected to the first stage compressor 30-1 so that the discharge pressure of the second stage compressor 30-2 reaches the design pressure.

Additionally, the control unit 60 controls the drive speed of the driving device 10-2 connected to the second stage compressor 30-2 based on the discharge pressure of the first stage compressor 30-1, and when the discharge pressure of the first stage compressor 30-1 is higher than the design pressure, the control unit 60 increases the drive speed of the driving device 10-2 connected to the second stage compressor 30-2 so that the discharge pressure of the first stage compressor 30-1 reaches the design pressure, and when the discharge pressure of the first stage compressor 30-1 is lower than the design pressure, the control unit 60 reduces the drive speed of the driving device 10-2 connected to the second stage compressor 30-2 so that the discharge pressure of the first stage compressor 30-1 reaches the design pressure.

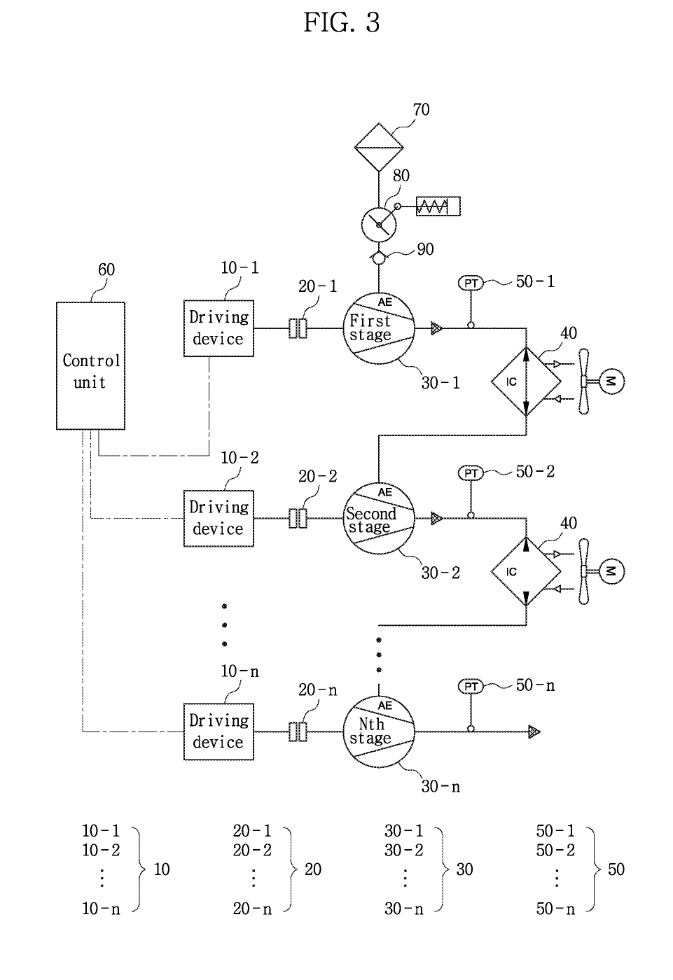

Meanwhile, when the multi-stage compression system is an n-stage compression system, i.e., the multi-stage compression system has n compressors 30 (here, n is an integer greater than 2) as shown in FIG. 3, the control unit 60 controls the drive speed of the driving device 10-1 connected to the first stage compressor 30-1 based on the discharge pressure of the final stage (n^{th} stage) compressor 30-n, and when the discharge pressure of the final stage (n^{th} stage) compressor 30-n is higher than the design pressure, the control unit 60 reduces the drive speed of the driving device 10-1 connected to the first stage compressor 30-1, and when the discharge pressure of the final stage (n^{th} stage) compressor 30-n is lower than the design pressure, increases the drive speed of the driving device 10-1 connected to the first stage compressor 30-1.

Additionally, the control unit 60 controls the drive speed of the driving device 10-2, . . . , 10-n connected to the remaining stage (2^{nd} stage, . . . , n^{th} stage) compressor 30-2, . . . , 30-n based on the discharge pressure of the front stage (1^{th} stage, . . . , n-1^{th} stage) compressor 30-1, . . . , 30-(n-1), and when the discharge pressure of the front stage (1^{st} stage, . . . , n-1^{th} stage) compressor 30-1, . . . , 30-(n-1) is higher than the design pressure, the control unit 60 increases the drive speed of the driving device 10-2, . . . , 10-n connected to the rear stage (2^{nd} stage, . . . , n^{th} stage) compressor 30-2, . . . , 30-n, and when the discharge pressure of the front stage (1^{st} stage, . . . , n-1^{th} stage) compressor 30-1, . . . , 30-(n-1) is lower than the design pressure, reduces the drive speed of the driving device 10-2, . . . , 10-n connected to the rear stage (2^{nd} stage, . . . , n^{th} stage) compressor 30-2, . . . , 30-n, so that the compression ratio of each stage 30:30-1, 30-2, . . . , 30-n may be uniformly maintained.

For reference, in FIGS. 2 and 3, the reference number 70 is a suction filter, the reference number 80 is a suction valve, and the reference number 90 is a check valve.

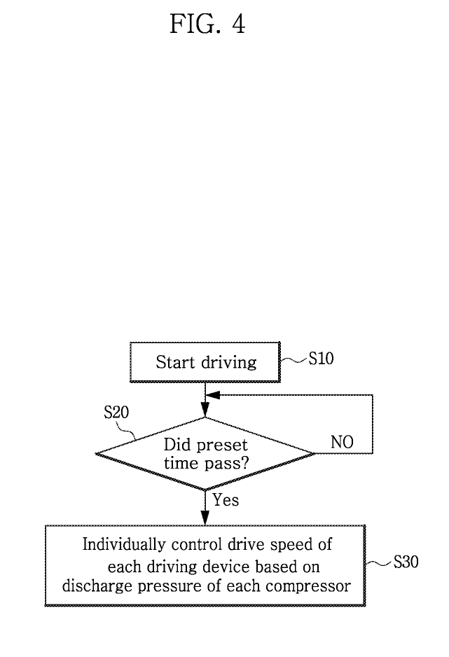

FIG. 4 is a processing diagram illustrating a control method for a multi-stage compression system according to an embodiment of the present disclosure.

First, when the control unit 60 applies an operation signal to the driving device 10 connected to each compressor 30 in response to a driving start request, each driving device 10 rotates at the rated drive speed in response to the operation signal, and as the driving device 10 rotates, the compressor 30 starts to drive at the same rotation speed as the driving device 10 by the coupling 20 connected to each driving device 10 (S10).

When driving starts through the above-described process S10, as the first stage compressor 30-1 rotates, air compression starts, and air discharged from the first stage compressor 30-1 is introduced into the second stage compressor 30-2 through the intercooler 40. The second stage compressor 30-2 connected to the driving device 10-2 by the coupling 20-2 rotates by the driving device 10-2, and while rotating, the second stage compressor 30-2 additionally compresses air introduced into the second stage compressor 30-2 and discharges the air.

When driving starts through the above-described process S10, the driving device 10-1 connected to the first stage compressor 30-1 and the driving device 10-2 connected to the second stage compressor 30-2 rotate at the rated speed for a preset time.

After driving starts through the above-described process S10, when the preset time passes (S20), the control unit 60 individually controls the drive speed of each driving device 10 based on the discharge pressure of each compressor 30 detected through the pressure detector 50 installed at the discharge end of each compressor 30 (S30).

In the above-described process S30, the control unit 60 controls the drive speed of the driving device 10-1 connected to the first stage compressor 30-1 based on the discharge pressure of the final stage (n^{th} stage) compressor 30-n, and the drive speed of the driving device 10-2, . . . , 10-n connected to the remaining stage (2¹ stage, . . . , n^{th} stage) compressor 30-2, . . . , 30-n based on the discharge pressure of the front stage (1^{st} stage, . . . , n-1^{th} stage) compressor 30-1, . . . , 30-(n-1).

For example, in the case of two compressors 30 as shown in FIG. 2, the control unit 60 controls the drive speed of the driving device 10-1 connected to the first stage compressor 30-1 based on the discharge pressure of the final stage compressor, i.e., the second stage compressor 30-2, and when the discharge pressure of the final stage compressor, i.e., the second stage compressor 30-2 is higher than the design pressure, the control unit 60 reduces the drive speed of the driving device 10-1 connected to the first stage compressor 30-1, and when the discharge pressure of the final stage compressor, i.e., the second stage compressor 30-2 is lower than the design pressure, increases the drive speed of the driving device 10-1 connected to the first stage compressor 30-1.

Additionally, the control unit 60 controls the drive speed of the driving device 10-2 connected to the second stage compressor 30-2 based on the discharge pressure of the front stage, i.e., first stage compressor 30-1, and when the discharge pressure of the first stage compressor 30-1 is higher than the design pressure, the control unit 60 increases the drive speed of the driving device 10-2 connected to the second stage compressor 30-2, and when the discharge pressure of the first stage compressor 30-1 is lower than the design pressure, reduces the drive speed of the driving device 10-2 connected to the second stage compressor 30-2.

Meanwhile, in the case of n compressors 30 (here, n is an integer greater than 2) as shown in FIG. 3, the control unit 60 controls the drive speed of the driving device 10-1 connected to the first stage compressor 30-1 based on the discharge pressure of the final stage (n^{th} stage) compressor 30-n, and when the discharge pressure of the final stage (n^{th} stage) compressor 30-n is higher than the design pressure, reduces the drive speed of the driving device 10-1 connected to the first stage compressor 30-1, and when the discharge pressure of the final stage (n^{th} stage) compressor 30-n is lower than the design pressure, increases the drive speed of the driving device 10-1 connected to the first stage compressor 30-1.

Additionally, the control unit 60 controls the drive speed of the driving device 10-2, . . . , 10-n connected to the remaining stage (2^{nd} stage, . . . , n^{th} stage) compressor 30-2, . . . , 30-n based on the discharge pressure of the front stage (1^{st} stage, . . . , n-1^{th} stage) compressor 30-1, . . . , 30-(n-1), and when the discharge pressure of the front stage (11^{st} stage, . . . , n-1^{th} stage) compressor 30-1, . . . , 30-(n-1) is higher than the design pressure, the control unit 60 increases the drive speed of the driving device 10-2, . . . , 10-n connected to the rear stage (2^{nd} stage, . . . , n^{th} stage) compressor 30-2, . . . , 30-n, and when the discharge pressure of the front stage (1^{st} stage, . . . , n-1^{th} stage) compressor 30-1, . . . , 30-(n-1) is lower than the design pressure, reduces the drive speed of the driving device 10-2, . . . , 10-n connected to the rear stage (2^{nd} stage, . . . , n^{th} stage) compressor 30-2, . . . , 30-n.

The multi-stage compression system and the control method thereof according to the present disclosure is not limited to the above-described embodiments, and various modifications may be made thereto without departing from the technical spirit of the present disclosure.

[Detailed Description of Main Elements]

| | |
|---|---|
| 10: Driving device | 20: Coupling |
| 30: Compressor | 40: Intercooler |
| 50: Pressure detector | 60: Control unit |
| 70: Suction filter | 80: Suction valve |
| 90: Check valve | |

What is claimed is:

1. A multi-stage compression system, comprising:
at least two compressors;
at least two driving devices connected to each of the compressors in series to drive the compressors connected in series;
at least two pressure detectors installed at a discharge end of each of the compressors to detect a discharge pressure of each compressor; and
a control unit configured to individually control a drive speed of each driving device based on the discharge pressure of each compressor detected through each of the pressure detectors.

2. The multi-stage compression system according to claim 1, further comprising:
at least two couplings connecting each of the compressors to the corresponding driving devices in series.

3. The multi-stage compression system according to claim 1, wherein the control unit controls a drive speed of a driving device connected to a first stage compressor based on a discharge pressure of a final stage (n^{th} stage) compressor, and a drive speed of a driving device connected to a remaining stage (2^{nd} stage, . . . , n^{th} stage) compressor based on a discharge pressure of a front stage (1^{st} stage, . . . , n-1^{th} stage) compressor.

4. The multi-stage compression system according to claim 3, wherein in case of two compressors, the control unit controls a drive speed of a driving device connected to a first stage compressor based on a discharge pressure of a second stage compressor, and when the discharge pressure of the second stage compressor is higher than a design pressure, the control unit reduces the drive speed of the driving device connected to the first stage compressor, and when the discharge pressure of the second stage compressor is lower than the design pressure, increases the drive speed of the driving device connected to the first stage compressor, and
the control unit controls the drive speed of the driving device connected to the second stage compressor based on the discharge pressure of the first stage compressor, and when the discharge pressure of the first stage compressor is higher than the design pressure, the control unit increases the drive speed of the driving device connected to the second stage compressor, and when the discharge pressure of the first stage compressor is lower than the design pressure, reduces the drive speed of the driving device connected to the second stage compressor.

5. The multi-stage compression system according to claim 3, wherein in case of more than two compressors, the control unit controls a drive speed of a driving device connected to a first stage compressor based on a discharge pressure of a final stage (n^{th} stage) compressor, and when the discharge pressure of the final stage (n^{th} stage) compressor is higher than a design pressure, the control unit reduces the drive speed of the driving device connected to the first stage compressor, and when the discharge pressure of the final stage (n^{th} stage) compressor is lower than the design pressure, increases the drive speed of the driving device connected to the first stage compressor, and
the control unit controls a drive speed of a driving device connected to a remaining stage (2^{nd} stage, . . . , n^{th} stage) compressor based on a discharge pressure of a front stage (1^{st} stage, . . . , n-1^{th} stage) compressor, and when the discharge pressure of the front stage (1^{st} stage, . . . , n-1^{th} stage) compressor is higher than the design pressure, the control unit increases a drive speed of a driving device connected to a rear stage (2^{nd} stage, . . . , n^{th} stage) compressor, and when the discharge pressure of the front stage (1^{st} stage, . . . , n-1^{th} stage) compressor is lower than the design pressure, reduces the drive speed of the driving device connected to the rear stage (2^{nd} stage, . . . , n^{th} stage) compressor.

6. A control method for a multi-stage compression system, comprising:
operating, by a control unit, a driving device connected to each compressor to start driving the multi-stage compression system, in response to a driving start request; and
after the driving starts, when a preset time passes, individually controlling a drive speed of each driving device based on a discharge pressure of each compressor detected through a pressure detector installed at a discharge end of each compressor.

7. The control method for a multi-stage compression system according to claim 6, wherein the individually controlling of a drive speed of each driving device comprises controlling a drive speed of a driving device connected to a first stage compressor based on a discharge pressure of a final stage (n^{th} stage) compressor, and a drive speed of a driving device connected to a remaining stage (2^{nd} stage, . . . , n^{th} stage) compressor based on a discharge pressure of a front stage (1^{st} stage, . . . , n-1^{th} stage) compressor.

8. The control method for a multi-stage compression system according to claim 7, wherein in case of two compressors, the individually controlling of a drive speed of each driving device comprises controlling a drive speed of a driving device connected to a first stage compressor based on a discharge pressure of a second stage compressor, and when the discharge pressure of the second stage compressor is higher than a design pressure, reducing the drive speed of the driving device connected to the first stage compressor, and when the discharge pressure of the second stage compressor is lower than the design pressure, increasing the drive speed of the driving device connected to the first stage compressor; and
controlling the drive speed of the driving device connected to the second stage compressor based on the discharge pressure of the first stage compressor, and when the discharge pressure of the first stage compressor is higher than the design pressure, increasing the drive speed of the driving device connected to the second stage compressor, and when the discharge pressure of the first stage compressor is lower than the design pressure, reducing the drive speed of the driving device connected to the second stage compressor.

9. The control method for a multi-stage compression system according to claim 7, wherein in case of more than two compressors, the individually controlling of a drive speed of each driving device comprises controlling a drive speed of a driving device connected to a first stage compressor based on a discharge pressure of a final stage (n^{th} stage) compressor, and when the discharge pressure of the final stage (n^{th} stage) compressor is higher than a design pressure, reducing the drive speed of the driving device connected to the first stage compressor, and when the discharge pressure of the final stage (n^{th} stage) compressor is lower than the design pressure, increasing the drive speed of the driving device connected to the first stage compressor; and
controlling a drive speed of a driving device connected to a remaining stage (2^{nd} stage, . . . , n^{th} stage) compressor based on a discharge pressure of a front stage (1^{st} stage, . . . , n-^{th} stage) compressor, and when the discharge pressure of the front stage (1^{st} stage, . . . , n-1^{th} stage) compressor is higher than the design pressure, increasing a drive speed of a driving device connected to a rear stage (2^{nd} stage, . . . , n^{th} stage) compressor, and when the discharge pressure of the front stage (1^{st} stage, . . . , n-1^{th} stage) compressor is lower than the design pressure, reducing the drive speed of the driving device connected to the rear stage (2^{nd} stage, . . . , n^{th} stage) compressor.
